(19) United States
(12) Patent Application Publication
(10) Pub. No.: US 2011/0116250 A1
(43) Pub. Date: May 19, 2011

(54) Multi-loop parallel and serial application chip bracket

(76) Inventor: Han-Ming Lee, Hsin Chu City (TW)

(21) Appl. No.: 12/590,698

(22) Filed: Nov. 13, 2009

(51) Int. Cl. F21V 9/16

(52) U.S. Cl. 362/84

(57) ABSTRACT

The present invention relates to a multi-loop parallel and serial application chip bracket, comprising a substrate, a plurality of chips, a plurality of conducting wires, positive and negative conducting brackets, a plurality of fluorescent layers and transparent adhesive tape and in particular one in which a pair of positive and negative conducting brackets are designed on both sides of the substrate for the placement of a plurality of conducting wires for a plurality of chips on the front side and back side for serial connection of the positive and negative conducting brackets on the two sides, therefore offering the single serial and parallel lighting effect of the front side and back side, wherein at least one pair of positive and negative conducting brackets may be added on the two sides of the substrate to realize the multi-stage single serial and parallel alternative switching cyclic permanent illuminating lighting control function and achieve the industrial application of the multi-facet chip loop interactive permanent illuminating lighting.

### BACKGROUND OF THE INVENTION

The ordinary power saving LED lamp is shown in FIG. 15 and widely used in various electronic products to replace the traditional tungsten-filament bulb. However, the high thermal energy effect of the single high efficiency chip due to being energized for a long period of time may still cause premature luminous decay shortening its life. And, its principle is that the chips in the chip cup above the conducting pin create the light source effect of forward refraction and focusing. But in actual applications, it is limited to the function of a single chip focusing without the light source effect of multi-facts lighting evenly, making it indeed necessary to make improvements.

### SUMMARY OF THE INVENTION

The primary purpose of the present invention is to provide a multi-loop serial and parallel application ship bracket, and in particular to one comprising a substrate, a plurality of chips, a plurality of conducting wires, positive and negative conducting brackets, a plurality of fluorescent layers and transparent adhesive tape so that the multi-facet chips loops illuminate permanently and alternatively.

The secondary purpose of the present invention is to provide a multi-loop serial and parallel application chip bracket and in particular to one in which a pair of positive and negative conducting brackets are designed on the two sides of the substrate for the placement of a plurality of conducting wires for a plurality of chips on the front side and back side for serial connection of the positive and negative conducting brackets on the two sides, therefore offering the single serial and parallel lighting effect of the front side and back side.

Another purpose of the present invention is to provide a multi-loop serial and parallel application chip bracket and in particular one in which the at least one pair of positive and negative conducting brackets may be added on the two sides of the substrate to realize the multi-stage single serial and parallel alternative switching cyclic permanent illuminating lighting control function.

One more purpose of the present invention is to provide a multi-loop serial and parallel application chip bracket and in particular one in which the surface of the chip blocks is covered with a fluorescent layer to allow the chips to provide the choice of color system effects of different light sources.

### BRIEF DESCRIPTION OF THE DRAWINGS

FIG. 1 is a 3D diagram of the present invention.

FIG. 2 is a schematic diagram of the components of the present invention.

FIG. 3 is a top-view cross-section schematic of the present invention.

FIG. 4 is a single serial and parallel schematic of the front side and back side of the present invention.

FIG. 5 is a cross-section 3D diagram of the present invention.

FIG. 6 is a lighting function schematic of the chips of the present invention.

FIG. 7 is a decomposition schematic of the assemblies of another embodiment of the multi-serial and parallel conducting bracket of the present invention.

FIG. 8 is a function diagram of another embodiment of the multi-serial and parallel conducting bracket of the present invention.

FIG. 9 is a decomposition schematic of the assemblies of another embodiment of the upper and lower serial and parallel conducting bracket of the present invention.

FIG. 10 is a function diagram of another embodiment of the upper and lower serial and parallel conducting bracket of the present invention.

FIG. 11 is a decomposition schematic of the assemblies of another embodiment of the 4 serial connection 2 loop conducting bracket of the present invention.

FIG. 12 is a function diagram of another embodiment of the 4 serial connection 2 loop conducting bracket of the present invention.

FIG. 13 is a decomposition schematic of the assemblies of another embodiment of the 6 serial connection 3 loop conducting bracket of the present invention.

FIG. 14 is a function diagram of another embodiment of the 6 serial connection 3 loop conducting bracket of the present invention.

FIG. 15 is a schematic of the traditional structure.

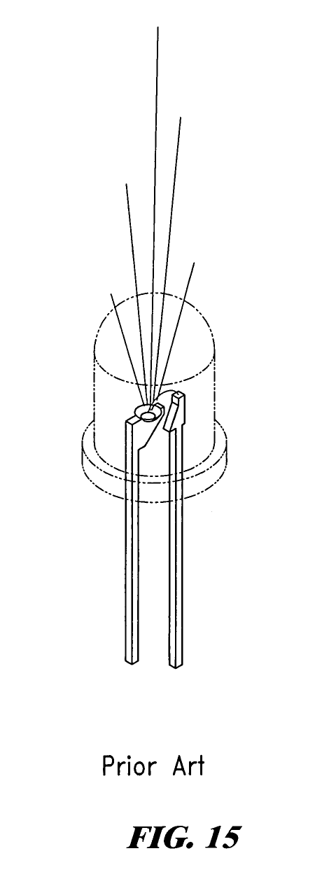

### DETAILED DESCRIPTION OF THE PREFERRED EMBODIMENT

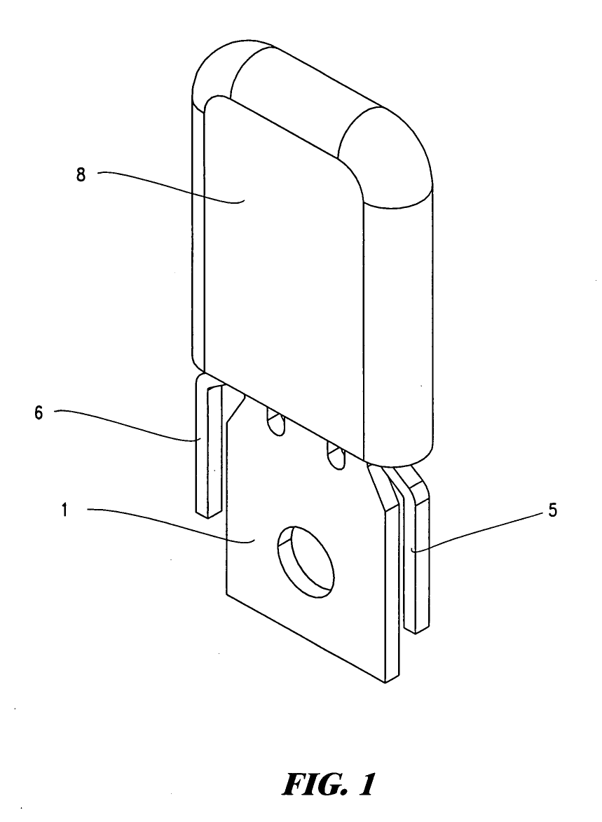

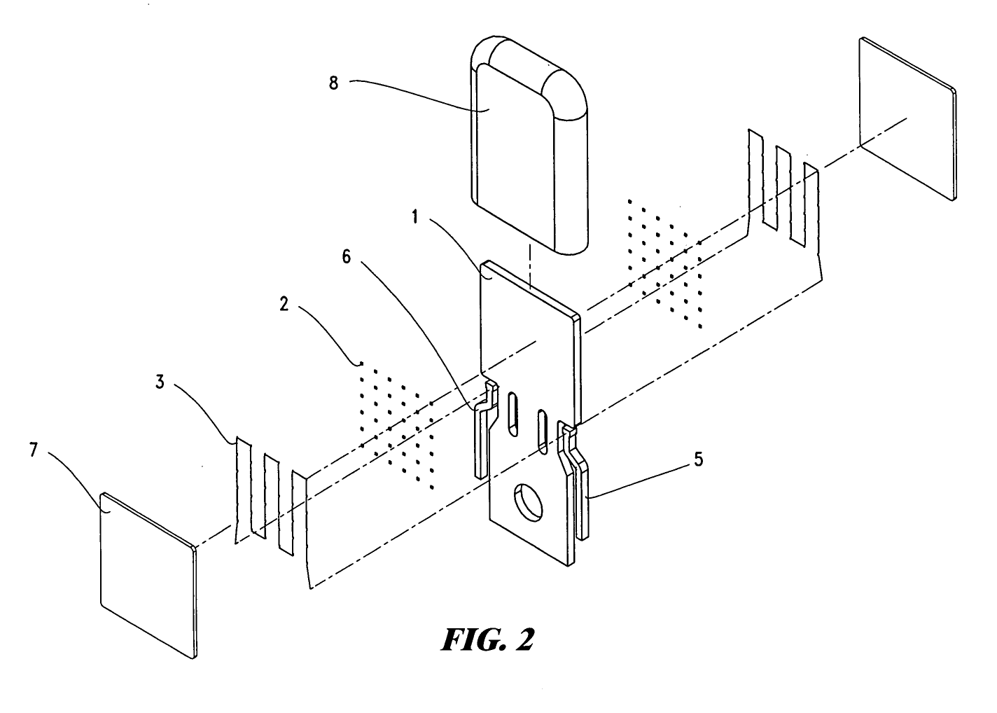

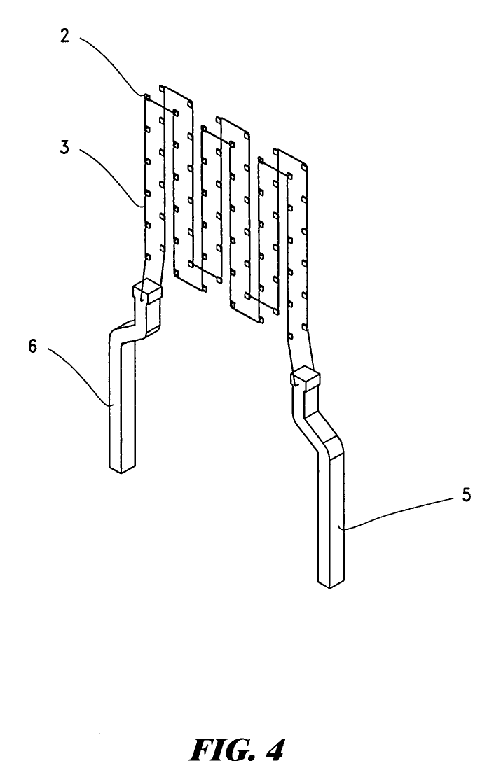

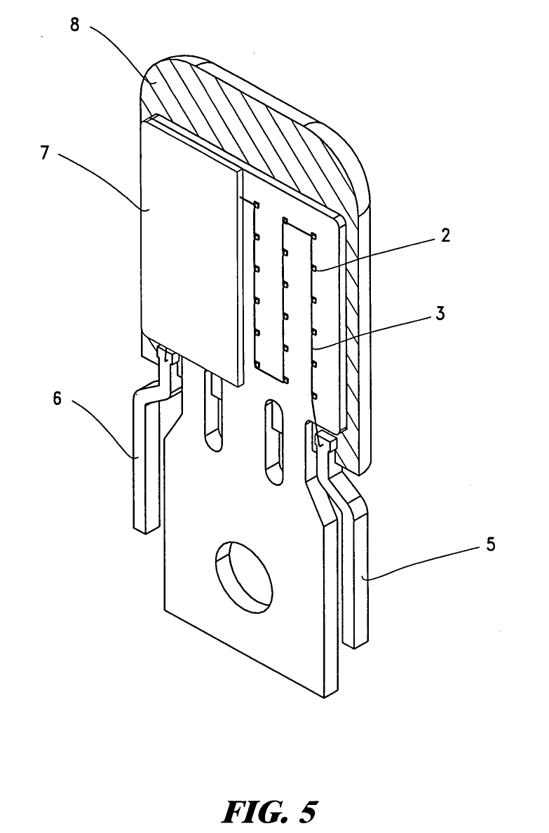

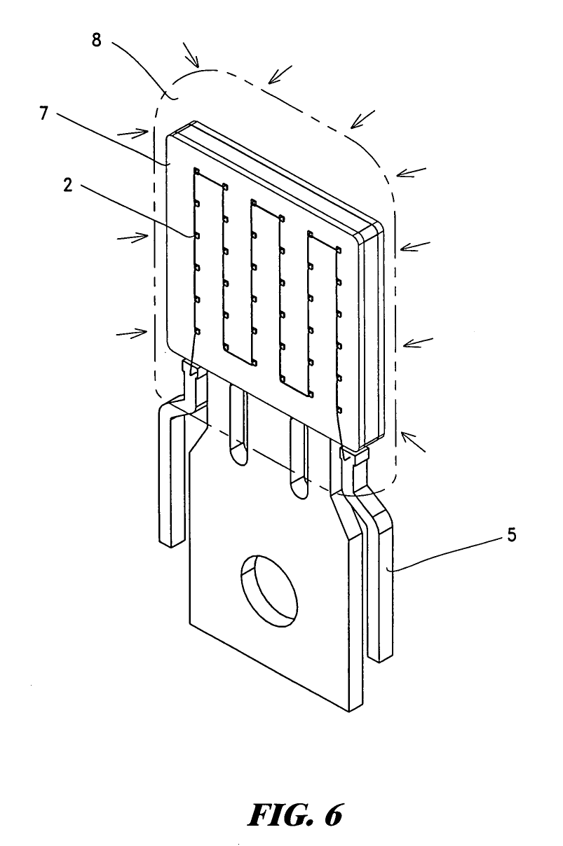

Please refer to FIGS. 1 through FIGS. 6. The present invention relates to a multi-loop serial and parallel application chip bracket, comprising the substrate 1, a plurality of chips 2, a plurality of conducting wires 3, the positive and negative conducting brackets 5, 6, a plurality of fluorescent layers 7 and transparent adhesive tape 8; the substrate 1 is a rectangle copper plate radiating substrate and the front side and back side of the substrate are provided for seating of the plurality of chips; the plurality of chips 2 are a lighting semi-conductor chip for distribution and attaching to the surface of the substrate 1; the plurality of conducting wires 3 are a conducting material wire body, the two ends of which are available for connecting the plurality of chips 2 and the positive and negative conducting brackets 5 and 6; the positive and negative conducting brackets 5 and 6 are symmetrical copper conducting brackets arranged on the two sides of the substrate 1, the bottom of the conducting brackets is provided for input of the positive and negative poles and the top is provided for serial connection of the plurality of conducting wires 3 with the plurality of chips 2 on the surface of the substrate 1 and then the positive and negative poles. The plurality of fluorescent layers 7 are a thin fluorescent containing layer covering the surface of the chip blocks; the transparent adhesive tape 8 is resin or silicon transmitting material injection, sealing the substrate 1, the plurality of chips 2, plurality of conducting wires 3, positive and negative conducting brackets 5 and 6, the plurality of fluorescent layers 7.

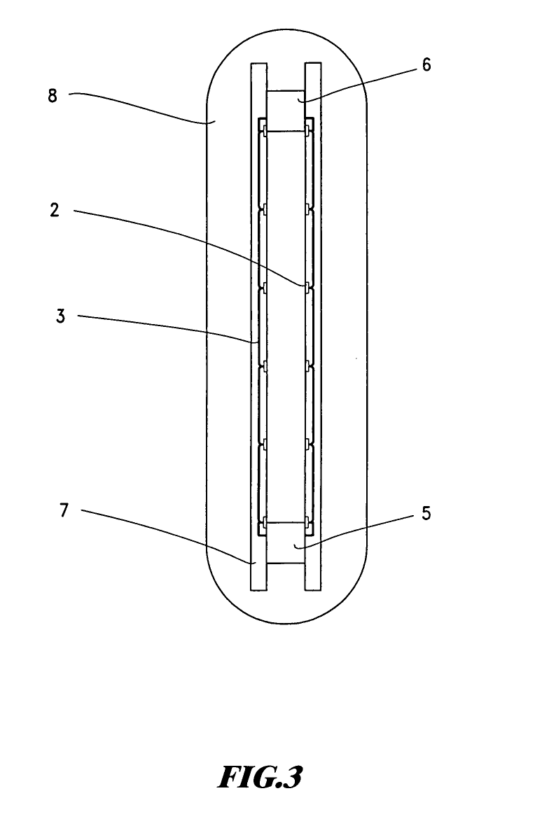

Please refer to FIGS. 3 through FIGS. 6 for the embodiment of the present invention. A pair of positive and negative conducting brackets 5 and 6 are designed on the two sides of the substrate 1 for serial connection of the plurality of conducting wires 3 with the plurality of chips 2 on the surface of the substrate 1 with the positive and negative poles, wherein the surface of the chip blocks is covered with a fluorescent layer 7 by design to offer the color system change effect of different light sources and the single serial and parallel lighting effect of the front side and back side.

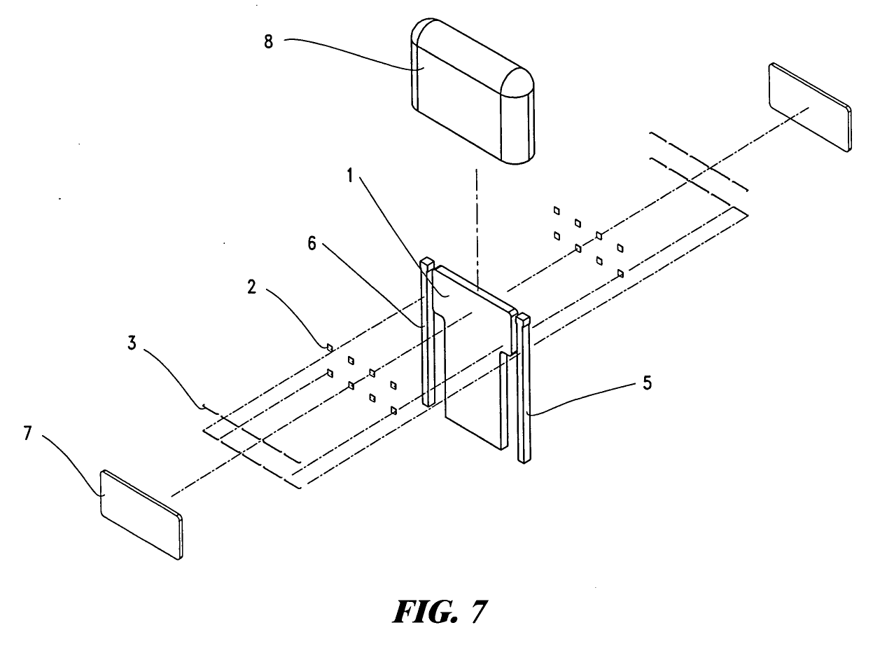

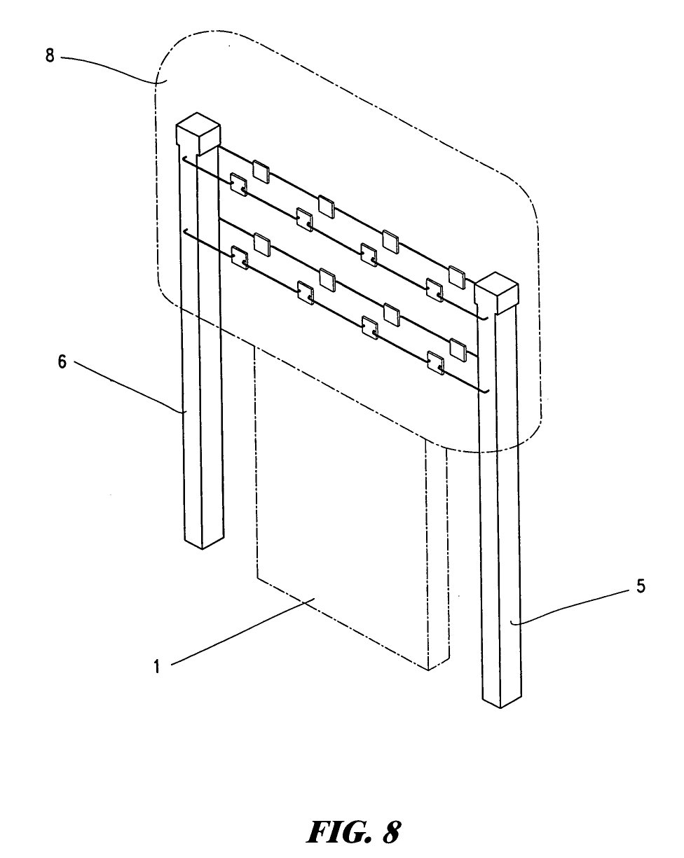

Please refer to FIG. 7 through FIG. 8 for another embodiment of the present invention. A pair of positive and negative poles 5 and 6 are designed on the two sides of the substrate 1 for serial connection of the plurality of conducting wires 3 with the plurality of chips 2 on the surface of the substrate 1 with the positive and negative poles to offer the multi-serial and parallel chip block lighting effect of the front side and back side.

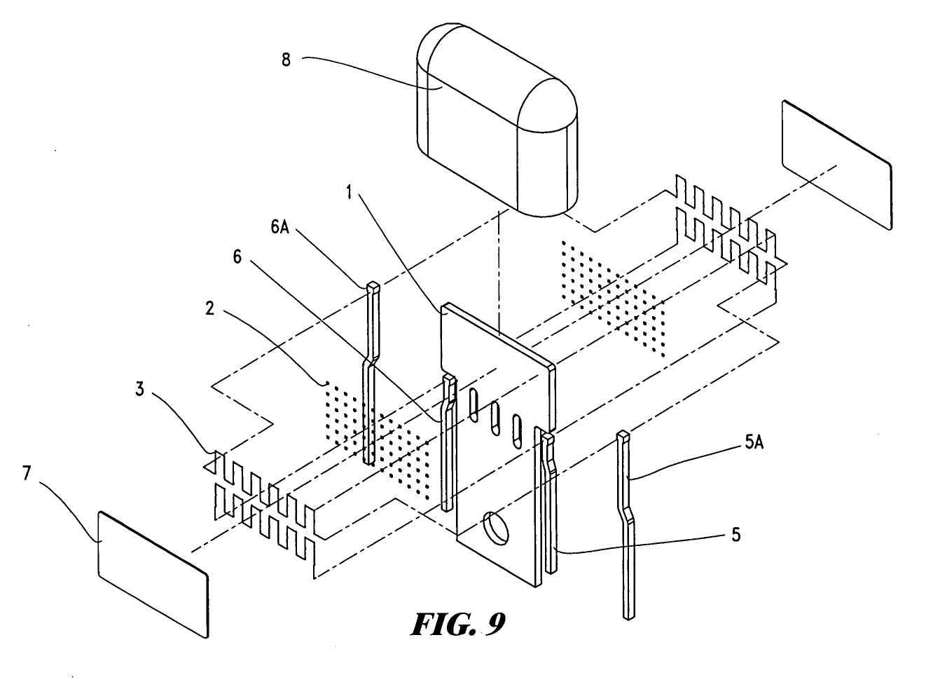

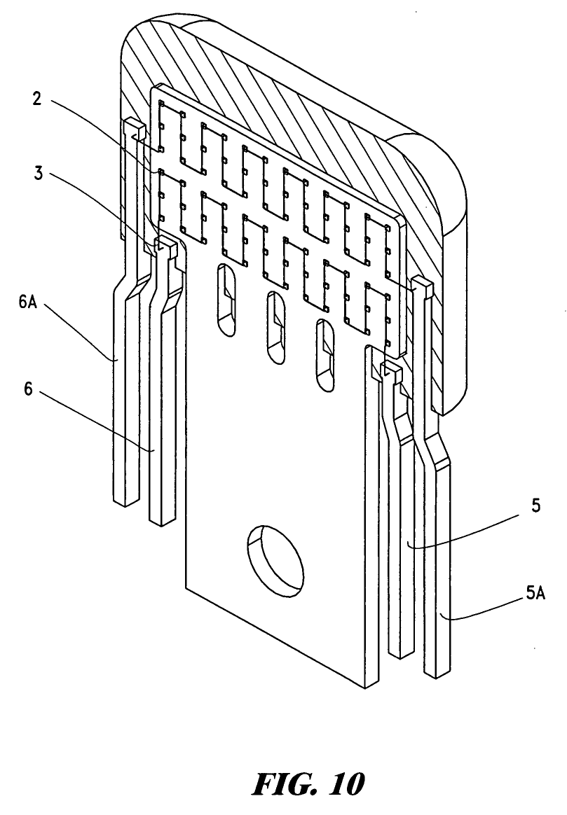

Please refer to FIG. 9 through FIG. 10 for another embodiment of the present invention. At least one pair of positive and negative conducting brackets 5, 5A, 6 and 6A may be added on the two sides of the substrate for serial connection of the plurality of conducting wires 3 with the plurality of chips 2 on the surface of the substrate 1 with the positive and negative poles to form the upper and lower single serial and parallel chip block so as control with IC and allow the positive and negative conducting brackets to offer the intermittent switching cyclic permanent lighting effect.

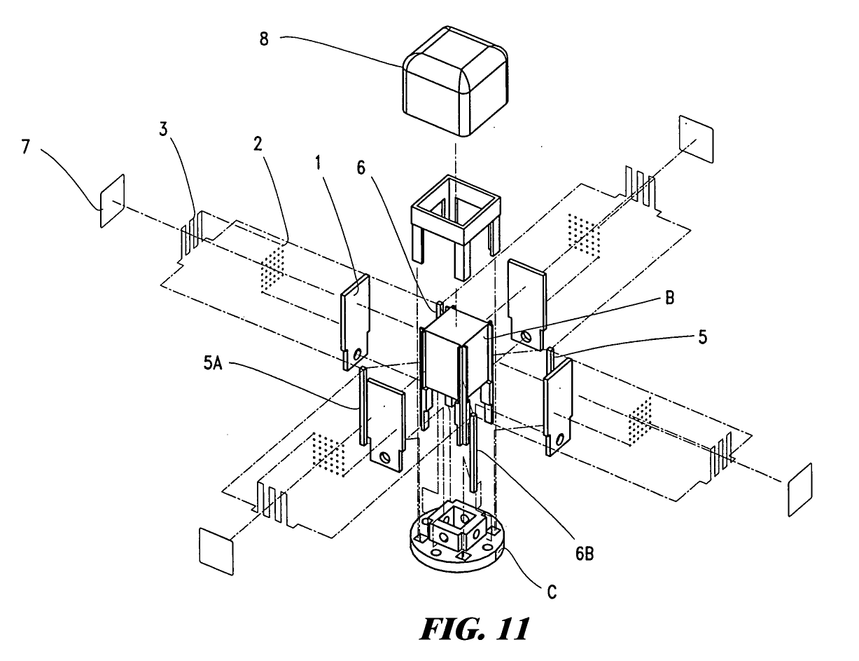

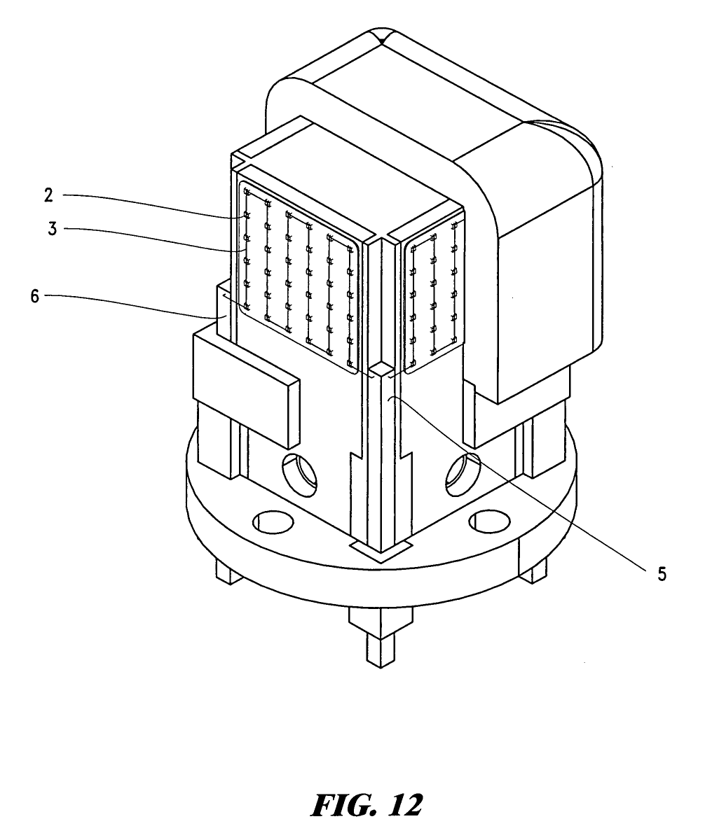

Please refer to FIG. 11 through FIG. 12 for another embodiment of the present invention. The quadrangle frame B and quadrangle base C are designed and 4 sets of substrates 1 are arranged to form a quadrangle bracket, the end points of the quadrangle bracket are available for placement of the positive and negative conducting brackets 5, 6, 5A and 6A so that the positive pole, negative pole, positive pole and negative pole are adjacent for serial connection of the plurality of conducting wires 3 with the plurality of chips 2 on the surface of the substrate 1 with the positive and negative poles to form the 4 serial connection 2 loop block chip multi-facet conducting and lighting effect.

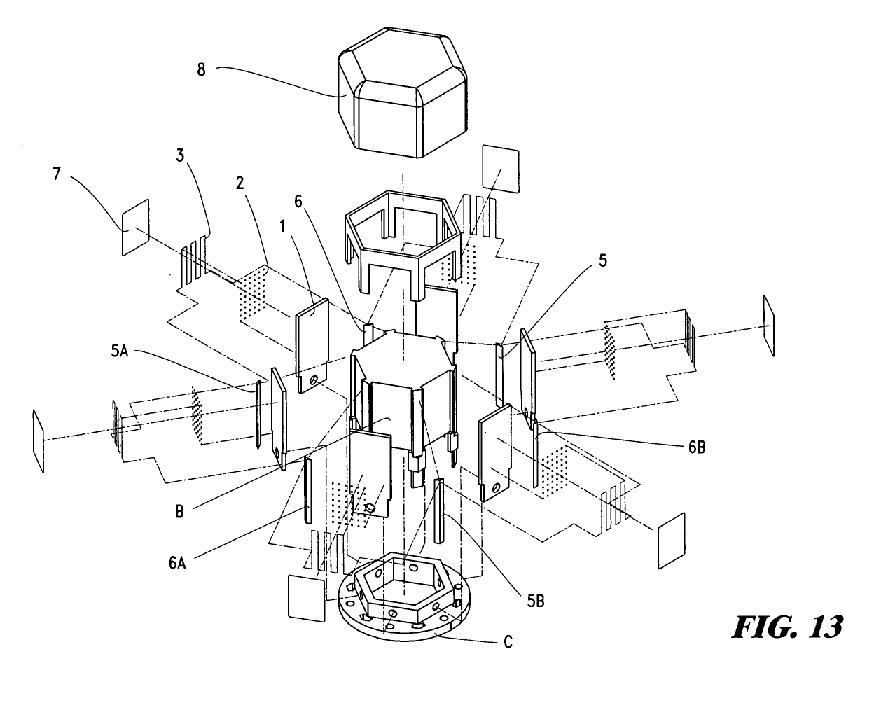

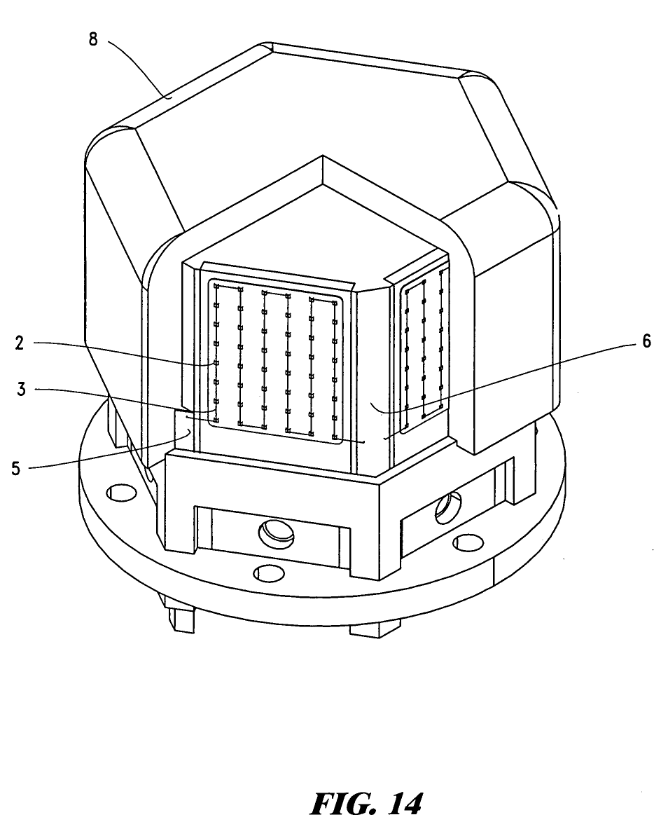

Please refer to FIG. 13 through FIG. 14 for another embodiment of the present invention. The hexagon frame B and hexagon base C are designed and 6 sets of substrates 1 are arranged to form a quadrangle bracket, the end points of the hexagon bracket are available for placement of the positive and negative conducting brackets 5, 6, 5A, 6A, 5B and 6B so that the positive pole, negative pole, positive pole, negative pole, positive pole and negative pole are adjacent for serial connection of the plurality of conducting wires 3 with the plurality of chips 2 on the surface of the substrate 1 with the positive and negative poles to form the 6 serial connection 3 loop block chip multi-facet conducting and lighting effect.

I claim:

1. A multi-loop serial and parallel application chip bracket, comprising a substrate, a plurality of chips, a plurality of conducting wires, positive and negative conducting brackets, a plurality of fluorescent layers and transparent adhesive tape, wherein, the substrate is a rectangle copper plate radiating substrate and the front side and back side of the substrate are provided for seating of the plurality of chips; the plurality of chips are a lighting semi-conductor chip for distribution and attaching to the surface of the substrate; the plurality of conducting wires are a conducting material wire body, the two ends of which are available for connecting the plurality of chips and the positive and negative conducting brackets and; the positive and negative conducting brackets and are symmetrical copper conducting brackets arranged on the two sides of the substrate, the bottom of the conducting brackets is provided for input of the positive and negative poles and the top is provided for serial connection of the plurality of conducting wires with the plurality of chips on the surface of the substrate and then the positive and negative poles; the plurality of fluorescent layers are a thin fluorescent containing layer covering the surface of the chip blocks; the transparent adhesive tape is resin or silicon transmitting material injection, sealing the substrate, the plurality of chips, plurality of conducting wires, positive and negative conducting brackets and the plurality of fluorescent layers; a pair of positive and negative conducting brackets are designed on both sides of the substrate for the serial connection of the plurality of conducting wires with the plurality of chips on the surface of the substrate and connection of the positive and negative poles, wherein the surface of the chip blocks is covered with a fluorescent layer by design to offer the color system change effect of different light sources and the single serial and parallel lighting effect of the front side and back side.

2. The multi-loop serial and parallel application chip bracket according to claim 1, wherein at least one pair of positive pole and negative pole may be added outside the substrate to offer the multi-loop multi-facet conducting and lighting effect.
